(19) United States
(12) Patent Application Publication
(10) Pub. No.: US 2013/0020447 A1
(43) Pub. Date: Jan. 24, 2013

(54) BEAM CLAMP

(71) Applicants: Richard W. Heath, Yorba Linda, CA (US); Scott Beutler, Scottsdale, AZ (US)

(72) Inventors: Richard W. Heath, Yorba Linda, CA (US); Scott Beutler, Scottsdale, AZ (US)

(73) Assignee: NIBCO, INC., Elkhart, IN (US)

(21) Appl. No.: 13/187,349

(22) Filed: Jul. 20, 2011

(51) Int. Cl. F16L 3/00; B23P 17/00; F16B 2/06

(52) U.S. Cl. 248/58; 403/299; 29/592

(57) ABSTRACT

A beam clamp for mounting to a flange of a beam or other support, having a main body and a set screw. The main body has an end wall, a first side wall and a second side wall. The first and second side walls each define a slot having an open end and a closed end. The end wall, the first side wall and the second side wall of the main body are formed by a unitary piece of material having a wall thickness. The main body further includes a first protrusion and a second protrusion that extend unitarily from the end wall. A first threaded opening and a second threaded opening pass through the end wall and a respective one of the first and second threaded openings such that each of the first threaded opening and the second threaded opening define a thread length that is greater than the wall thickness.

### BACKGROUND OF THE INVENTION

1. Field of the Invention

The present invention generally relates to a beam clamp for supporting a load. More particularly, the present invention relates to an improved beam clamp that can be clamped to a beam flange and receive a threaded support rod.

2. Description of the Related Art

Beam clamps are commonly used as a portion of a support assembly for supporting objects relative to a support structure, such as a beam. The clamp typically is secured to the beam and receives a support rod, which can be a threaded rod. The threaded rod can be used to support an object, such as a pipe, for example. Usually, the threaded rod supports the object through one or more intermediate support elements, such as a pipe hanger, for instance. Because many beam clamps may be used at spaced locations to support a single pipe, it is desirable that the beam clamp be economical to manufacture, while meeting or exceeding strength or load requirements. Some prior art beam clamps are constructed from a flat piece of material that is bent into a desired shape to form a main body of the clamp. The main body is provided with two threaded openings—a first to receive a set screw for mounting the beam clamp and a second for receiving the threaded support rod. Thus, the length of the threaded openings is typically determined by the thickness of the piece of material used to create the main clamp body.

### SUMMARY OF THE INVENTION

In some cases, it is desirable to provide threaded openings in a beam clamp that are longer than a thickness of the main clamp body that is necessary or desirable for the particular application. Providing additional material thickness beyond that necessary to meet load requirements increases manufacturing costs and may increase the difficulty of manufacturing, for example, by making bending of the main clamp body more difficult. Thus, a need exists for providing an increased thread length without undesirably increasing manufacturing costs and/or without increasing the wall thickness of the entire main clamp body. In some embodiments, the beam clamp is provided with at least one protrusion that, preferably, is unitarily formed with the remainder of the main clamp body to provide a thread length of a threaded opening that is greater than the wall thickness of the main clamp body.

A preferred embodiment is a beam clamp for mounting to a flange of a beam or other support, having a main body and a set screw. The main body has an end wall, a first side wall and a second side wall. The first side wall defines a first slot having an open end and a closed end and the second side wall has a second slot having an open end and a closed end. The first slot and the second slot open in the same direction and are configured to receive the flange. The end wall, the first side wall and the second side wall of the main body are formed by a unitary piece of material having a wall thickness. The main body further includes a first protrusion and a second protrusion that extend unitarily from the end wall. A first threaded opening and a second threaded opening pass through the end wall and a respective one of the first and second protrusions such that each of the first threaded opening and the second threaded opening define a thread length that is greater than the wall thickness. The set screw engages the first threaded opening.

In some arrangements, the first and second protrusions extend in the same direction from the end wall as the first and second side walls. An end of each of the first and second protrusions can be substantially aligned with an edge of each of the first and second slots closest to the end wall. Preferably, the thread length of each of the first and second threaded openings is approximately equal to or greater than a diameter of the respective one of the first and second threaded openings. In some arrangements, the thread length of the first threaded opening is equal to the thread length of the second threaded opening. The diameter of the first threaded opening can be equal to the diameter of the second threaded opening. The first threaded opening and the second threaded opening preferably are spaced from one another in a longitudinal direction of the main body. In some arrangements, the first threaded opening is aligned with the first and second slots such that the set screw can engage the flange. Preferably, the second threaded opening is between the closed ends of the first and second slots and an edge of the main body opposite the open ends of the first and second slots such that a threaded rod received by the second threaded opening and extending from the end wall to an edge of the first and second side walls opposite the end wall will not interfere with the flange received within the first and second slots.

A preferred embodiment includes a method of manufacturing a beam clamp configured to be clamped to a flange of a beam or other support. The method includes stamping a flat work piece having an end wall portion, a first side wall portion extending from one edge of the end wall portion and a second side wall portion extending from an opposite edge of the end wall portion. The stamping includes creating a first slot in the first side wall portion, the first slot having an open end and a closed end, and creating a second slot in the second side wall portion, the second slot having an open end and a closed end. The first and second slots open in the same direction. The first side wall portion is bent approximately ninety degrees relative to the end wall portion and the second side wall portion is bent approximately ninety degrees relative to the end wall portion in the same direction as the first side wall portion. The stamping further includes creating a first opening having a first initial diameter and creating a second opening having a second initial diameter, deforming a portion of the work piece surrounding the first opening to create a first protrusion surrounding the first opening and thereby enlarging the first opening such that the first opening defines a first enlarged diameter that is greater than the first initial diameter, and deforming a portion of the work piece surrounding the second opening to create a second protrusion surrounding the second opening and thereby enlarging the second opening such that the second opening defines a second enlarged diameter that is greater than the second initial diameter. The method also includes creating threads in the first opening and creating threads in the second opening.

In some embodiments, the bending and deforming comprises bending the first and second side wall portions and creating the first and second protrusions all extending in the same direction from the end wall portion. The first opening and the second opening can be spaced in a longitudinal direction along the end wall portion, aligning the first opening with the first and second slots and aligning the second opening with a portion of the first and second side walls behind a closed end of the first and second slots. A set screw can be threaded into the first opening. The method can also include threading a nut onto the set screw prior to the threading of the set screw into the first opening. In some embodiments, the bending of the first side wall and second side wall portions is done before the deforming that creates the first and second protrusions.

A preferred embodiment is an assembly including a beam having a flange. A beam clamp includes a main body and a set screw. The main body has an end wall and first and second side walls created by a unitary piece of material having a wall thickness. The first and second side walls extend in the same direction from the end wall. Each of the first and second side walls defines a slot that open in the same direction relative to the main body. The end wall includes a first protrusion and a second protrusion. A first threaded opening passes through the end wall at the first protrusion and a second threaded opening passes through the end wall at the second protrusion such that the first threaded opening defines a first thread length and the second threaded opening defines a second thread length, and both the first and second thread lengths are greater than the wall thickness. The main body is placed onto the beam with the flange positioned within the slots of the first and second side walls. The set screw is threaded into the first threaded opening and engaged with the flange to secure the beam clamp to the beam. A threaded rod has a first end portion and a second end portion, the first end portion is threaded into the second threaded opening. A pipe hanger is coupled to the second end portion of the threaded rod and a pipe is supported by the pipe hanger.

In some arrangements, the beam clamp is oriented such that the set screw engages a bottom surface of the beam flange. In other arrangements, the beam clamp is oriented such that the set screw engages a top surface of the beam flange. The first protrusion and the second protrusion can extend in the same direction as the first and second side walls. Preferably, the first protrusion and the second protrusion extend in only one direction from the end wall.

### BRIEF DESCRIPTION OF THE DRAWINGS

These and other features, aspects and advantages of the beam clamp are described below with reference to drawings of preferred embodiments, which are intended to illustrate and not to limit the present invention. The drawings contain seven (7) figures.

FIG. 1 is a perspective view of brace assemblies that support pipes relative to a support beam. The illustrated brace assemblies employ an embodiment of the present beam clamp.

FIG. 2 is a perspective view of a beam clamp of a brace assembly of FIG. 1 separated from the brace assembly and including a main body, a set screw and a lock nut.

FIG. 3 is a side view of the main body of the beam clamp of FIG. 2.

FIG. 4 is a front view of the main body of the beam clamp of FIG. 2.

FIG. 5 is a top view of the main body of the beam clamp of FIG. 2.

FIG. 6 is a plan view of a work piece that can be formed into a main body of a beam clamp, such as the main body of FIGS. 3-5.

FIGS. 7A-7C are partial views of a base wall of a main body of a beam clamp in several stages of manufacture.

### DETAILED DESCRIPTION OF THE EMBODIMENTS

The present beam clamp is described herein with reference to one or more embodiments and/or environments of use. The terms “top,” “bottom,” “side” and other relative terms are merely used to provide a frame of reference for this written description. The structures described herein can be mounted in any particular orientation and, therefore, the usage of these terms should not be considered limiting in any manner.

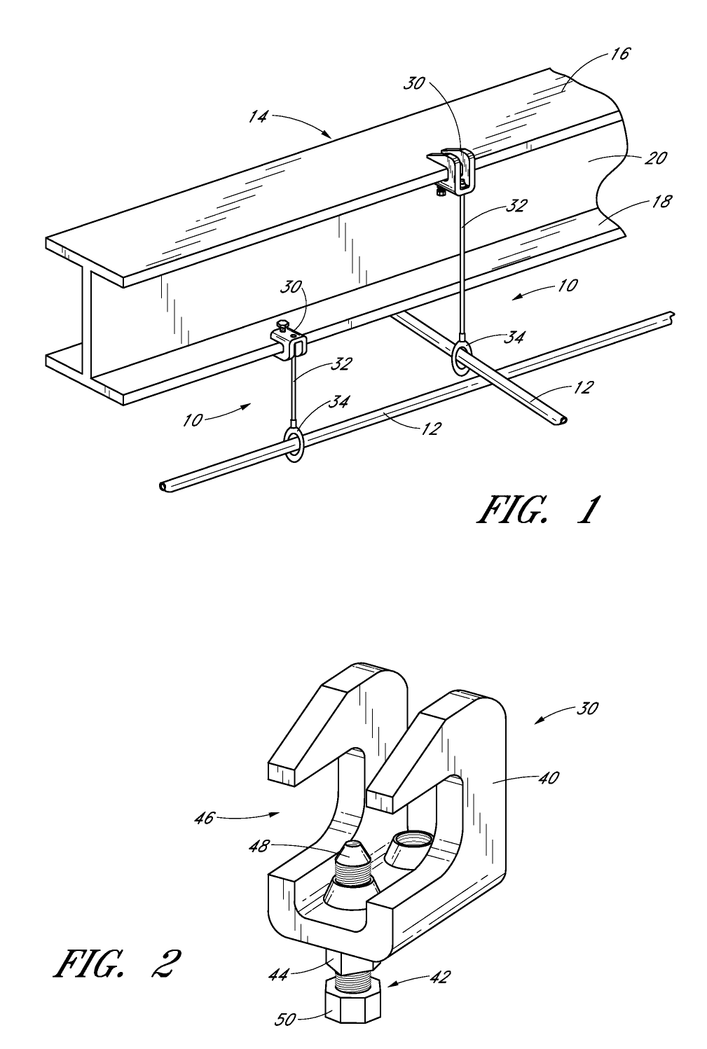

FIG. 1 illustrates a pair of brace assemblies, each generally indicated by the reference numeral 10, which are utilized to provide support for objects, such as pipes 12, relative to a support structure, such as a beam 14 or other flanged structure. As used herein, a flanged structure refers to any suitable support structure that incorporates a flange, or similar generally thin, flat portion, suitable for use as a mounting point for a brace assembly 10. For convenience, the term “beam” or “flange” is used herein when referring to a beam or any other suitable support structure having a flange or flange-like portion. In the illustrated arrangement, the beam 14 includes an upper flange 16 and a lower flange 18 spaced by a web 20. The brace assemblies 10 can be secured to either of the upper or lower flanges 16, 18. As illustrated, one brace assembly 10 is secured to the upper flange 16 and the other brace assembly 10 is secured to the lower flange 18. The brace assemblies 10 can support pipes 12 extending parallel or perpendicular with respect to the beam 14 or flanges 16, 18.

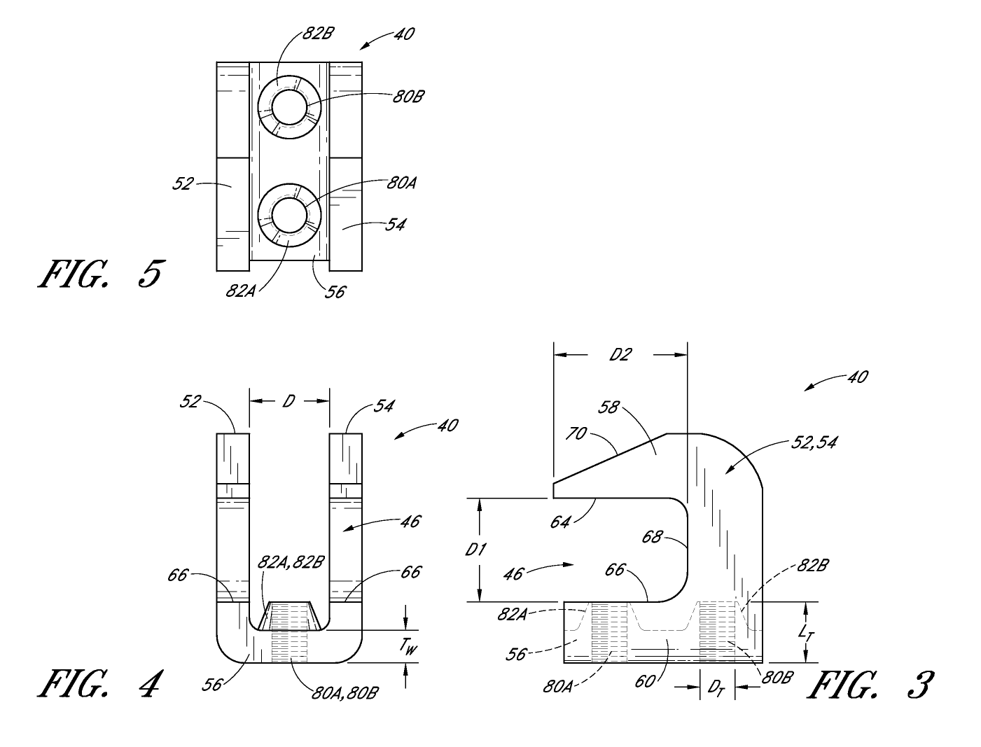

Each brace assembly 10 preferably includes a hanger or beam clamp 30, a hanger or support rod 32 and a pipe hanger 34. The support rod 32 preferably is a threaded support rod, which is threaded along all or a portion of its length and configured to threadably engage the beam clamp 30 and the pipe hanger 34. The pipe hanger 34 can be of any suitable construction configured to supportably engage a pipe 12 and connect to a support rod 32. The beam clamp 30 is further described below with reference to FIGS. 2-7. The beam clamp 30 preferably can be coupled to the beam 14 in at least two orientations, as described below.

With reference to FIG. 2, the beam clamp 30 is illustrated separate from the beam 14 and the remaining components of the brace assemblies 10. The beam clamp 30 preferably includes a clamp body or main body 40, a set screw 42 and a lock nut 44. The main body 40 is generally C-shaped in a side view to form a mouth, opening or slot 46 that is configured to receive a flange 16, 18. The set screw 42 engages the main body 40 and is adjustable relative to the main body 40 such that the set screw 42 can be used to engage the flange 16, 18 and secure the clamp 30 to the flange 16, 18. Preferably, the set screw 42 includes external threads that threadably engage the main body 40. The set screw 42 includes an end or tip 48 that is positionable within the slot 46 and configured to engage the flange 16, 18. Preferably, the end 48 is a cup-point; however, other end types (e.g., point, flat) can also be used. The set screw 42 also has a tool end or a head 50, which may be a square end, hex end or any other suitable shape that is capable of engagement with a tool used for turning the set screw 42. If present, the lock nut 44 preferably threadably engages the set screw 42 and can be tightened against an outer surface of the main body 40 to inhibit undesired movement of the set screw 42. In addition or alternatively, other suitable fastening or securing mechanisms can be used to secure the main body 40 relative to the flange 16, 18.

With reference to FIGS. 3-5, as described above, the main body 40 preferably is generally C-shaped in a side view and defines the slot 46, which opens to one side of the main body 40 and passes laterally through the main body 40. The illustrated main body 40 includes a first side wall portion 52, a second side wall portion 54 and an end wall portion 56, which may also be referred to herein as a base wall, connecting wall or a bridge portion. Preferably, the first side wall 52 and the second side wall are mirror images of one another. Accordingly, unless otherwise noted, features, shapes and functions described in connection with one of the side walls 52, 54 may equally apply to the other side wall 52, 54. Preferably, the first side wall 52 is spaced from the second side wall 54 by a distance D, which is sufficient to accommodate a shaft portion of the set screw 42 and a support rod 32. The end wall 56 joins the first side wall 52 and the second side wall 54 at respective lower ends thereof (relative to the orientation of FIGS. 2-5). Preferably, the first side wall 52, second side wall 54 and end wall 56 are formed by a unitary, monolithic or single piece of an appropriate material.

Preferably, each side wall 52, 54 includes a first or upper arm portion 58 and a second or lower arm portion 60, which are spaced from one another and interconnected by a vertical or column portion 62. The upper arm 58, vertical portion 62 and lower arm 60 cooperate to define the slot 46. In particular, the upper arm 58 defines an upper surface 64 of the slot 46, the lower arm 60 defines a lower surface 66 of the slot 46, and the vertical portion 62 defines an end surface 68 of the slot 46. Thus, the end surface 68 defines a closed end of the slot 46 and an open end of the slot is opposite the end surface 68. Preferably, each of the surfaces 64, 66, 68 is planar or substantially planar. A transition between each of the surfaces 64, 66 and the end surface 68 preferably is rounded. The upper surface 64 and the lower surface 66 preferably are at least substantially parallel to one another and define a distance D1 therebetween. The end surface 68 preferably is at least substantially perpendicular to the upper and lower surfaces 64, 66. A distance D2 is defined between the end surface 68 and an opposite end of the upper surface 64 or lower surface 66. The distances D1 and D2 preferably are sufficient to permit the main body 40 to be securely clamped to a flange, such as flanges 16, 18 of the beam 14. A forward end, free end or end of the upper arm 58 nearest the open end of the slot 46 can have a downwardly-sloped or chamfered upper surface 70. That is, the sloped surface 70 slopes downwardly in a direction from the closed end of the slot 46 toward the open end of the slot 46. The sloped surface 70 facilitates positioning the beam clamp 30 in spaces having small clearances.

The end wall 56 includes at least one and, preferably, a pair of through holes or openings 80A, 80B spaced from one another along a longitudinal direction of the main body 40. Preferably, the openings 80A and 80B are threaded such they can threadably engage the set screw 42 and the support rod 32, respectively. The openings 80A, 80B can be the same diameter or can differ in diameter. The opening 80A is positioned in alignment with the slot 46 and the opening 80B is not in alignment with the slot 46. That is, the opening 80B is located between a closed end of the slot 46 and an edge of the main body 40 opposite the open end of the slot 46. Accordingly, the opening 80A opens into the slot 46 such that the set screw 42, when passed through the opening 80A, will engage a flange 16, 18 positioned within the slot 46. When a support rod 32 is passed through the opening 80B, it can extend between the first and second side walls 52, 54 without interference with a flange 16, 18 positioned within the slot 46.

Preferably, surrounding each of the openings 80A, 80B is a respective protrusion 82A, 82B, which extends upwardly (in the same direction as the side walls 52, 54) from the end wall 56. In the illustrated arrangement, the protrusions 82A, 82B extend in only one direction from the end wall 56. Accordingly, the surface of the end wall 56 opposite the protrusions 82A, 82B is substantially flat and smooth to provide a good contact surface for the lock nut 44, such that a substantial portion or entirety of the corresponding surface of the lock nut 44 contacts the end wall 56. Preferably, the protrusions 82A, 82B are not present or do not extend from the outward-facing surface of the end wall 56. An upper surface 84 of the protrusions 82A, 82B preferably is located in substantially the same plane or below (toward the end wall 56) relative to the lower surface 66 of the slot 46 such that the protrusions 82A, 82B will not interfere with a flange positioned within the slot 46. Locating the upper surfaces 84 close to or substantially aligned with the lower surface 66 of the slot 46 maximizes the length of the protrusions 82A, 82B without increasing the overall height of the main body 40.

Preferably, the protrusions 82A, 82B are unitarily or monolithically formed with the end wall 56. That is, the protrusions 82A, 82B and end wall 56 are formed from a single piece of material, which is deformed to create the protrusions 82A, 82B. Advantageously, such an arrangement permits the openings 80A, 80B to have a length that is greater than a wall thickness T_{W} of the end wall 56. In particular, the openings 80A, 80B define a length, which preferably is substantially equivalent to a length of the threads provided within the openings 80A, 80B and is referred to as a thread length L_{T} of the openings 80A, 80B. The threaded openings 80A, 80B also define a thread diameter D_{T}. Preferably, the opening length or thread length T_{L} is at least equal to, or is greater than, the thread diameter D_{T}. In some arrangements, the opening length or thread length T_{L} is equal to or substantially equal to the thread diameter D_{T}. In other arrangements, the opening length or thread length T_{L} is greater than the thread diameter D_{T}. The thread length T_{L} and the thread diameter D_{T} of each opening 80A, 80B may be equal to one another or different from one another.

Advantageously, such an arrangement provides increased strength as a result of the increased thread length T_{L} without requiring an increase in the wall thickness of the main body 40 or a threaded insert to be provided, which permits cost-effective manufacture. Although not presently preferred, in some arrangements, a threaded insert could be used to provide the threaded openings 80A, 80B and the protrusions 82A, 82B and the threaded insert can be secured to the main body 40 by any suitable manner, such as by staking, for example. In addition, because the thread length T_{L} can be made equal to or greater than the thread diameter D_{T}, the beam clamp 30 can satisfy codes that require the thread length T_{L} to be at least as long as the thread diameter D_{T}, which doing so in a cost-effective manner. Although not presently preferred, in some arrangements, the opening length or thread length T_{L} could be slightly less than, or substantially less than, the thread diameter D_{T} for use in small load applications or applications without stringent code requirements. Preferably, each of the openings 80A, 80B and respective protrusions 82A, 82B are configured to have a thread length T_{L} that is equal to or greater than the thread diameter D_{T}. However, in some arrangements, only one of the openings 80A, 80B and respective protrusions 82A, 82B can be so configured. In some arrangements, only one protrusion 82A or 82B may be provided, with the other opening 80A or 80B having a length equivalent or substantially equivalent to the wall thickness T_{W} of the end wall 56.

The above-described components of the beam clamp 30 can be constructed of any suitable material by any suitable process. The beam clamp 30 can be constructed with dimensions suitable for the desired application(s). However, in one embodiment, the main body 40 is constructed from hot-rolled steel (such as steel meeting the ASTM A-569 standard) having a thickness of about 0.228 inches. The main body 40 can have height and length dimensions (in a side view) of about 1.625 inches and 1.5 inches, respectively. The distance D between the inner surfaces of the first and second side walls 52, 54 can be about 0.583 inches. A height of the slot 46 (length of the end surface 68) can be about 0.75 inches and a depth of the slot 46 (length in the direction from the open end to the closed end) can be about 0.875 inches. However, in another arrangement, the height of the slot 46 can be about 1¼ inches, for use with thicker flanges. The thread lengths L_{T} of the openings 80A, 80B can be at least about 0.375 inches. Similarly, the thread diameter D_{T} of the openings 80A, 80B can be about 0.375 inches, or ⅜ inch, such that the opening 80B can threadably receive a ⅜ inch support rod 32. The centers of the openings 80A, 80B can be spaced about 0.75 inches from one another. These dimensions are preferred for an embodiment of the beam clamp configured for use with a ⅜ inch support rod 32. However, the dimensions of the beam clamp 30 can be modified for use with other size support rods, for other flange sizes and for other strength requirements to suit other applications, as well.

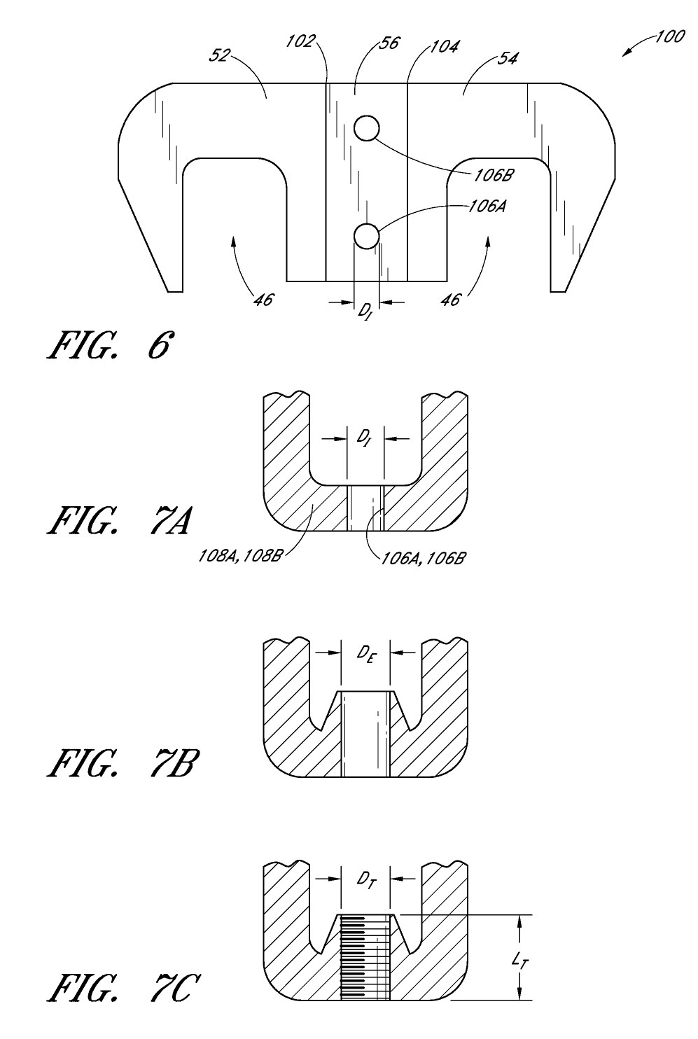

The main body 40 can be constructed by any suitable process, including machining, casting and forging. However, in one embodiment, the main body 40 is stamped from a flat piece of material. With reference to FIGS. 6 and 7A-7C, a work piece 100 is shown that is processed to create the main body 40. In FIG. 6, the work piece 100 is stamped into a generally rectangular, planar shape, which forms substantially the same outline as the main body 40. That is, the work piece 100 includes the end wall portion 56 and first and second side wall portions 52, 54 extending from opposite sides of the end wall portion 56 and separated from the end wall portion 56 at junctions 102 and 104, respectively. Each of the first and second side wall portions 52, 54 defines a slot 46.

The work piece 100 of FIG. 6 illustrates holes 106A, 106B, which are further processed to form openings 80A, 80B, respectively. The holes 106A and 106B can be formed with the work piece 100 in a flat condition as shown in FIG. 6; however, preferably, the holes 106A and 106B are initially formed after the side wall portions 52, 54 have been bent relative to the end wall 56, as shown in FIG. 7A. In either case, the holes 106A, 106B have an initial diameter D_{I}, which is less than the thread diameter D_{T}. If desired, the junctions 102, 104 can be provided with a crease or indentation to facilitate bending of the work piece 100. The side walls 52, 54 are bent, preferably approximately 90 degrees with respect to the end wall 56, along the lines marked 102 and 104, respectively.

The respective portions of material 108A, 108B surrounding the holes 106A, 106B is drawn, or otherwise manipulated, to create the protrusions 82A, 82B. Preferably, the material 108A, 108B is manipulated by a multi-step (e.g., a two-step) drawing process. However, any suitable method for deforming the material 108A, 108B to create the protrusions 82A, 82B may be employed. The work piece 100 is shown in FIG. 7B with the protrusions 82A, 82B formed. During the drawing process, or other protrusion-forming process, the holes 106A, 106B may have been enlarged from the initial diameter D_{I} (defining an enlarged diameter D_{E}) as a result of the deformation of the material portions 108A, 108B surrounding the initial holes 106A, 106B to create the protrusions 82A, 82B. However, preferably the diameter of the holes 106A, 106B after the protrusions 82A, 82B have been formed is sufficiently small to allow threads of an appropriate diameter to be subsequently formed. Once the protrusions 82A, 82B are formed, preferably, the holes 106A, 106B are tapped to create threaded openings 80A, 80B, as shown in FIG. 7C.

The above-described method is especially suited for automated assembly lines, wherein stamping, punching and bending operations can be efficiently executed. The simplicity and speed of this manufacturing method results in an end-product that is economical to manufacture and, thus, is desirably inexpensive. Of course, alternatively, and as mentioned before, the components of the beam clamp 30 may be machined or otherwise manufactured, but this process is more time consuming and, consequently, more expensive.

In a preferred method of assembling the beam clamp 30, the lock nut 44 is assembled onto the set screw 42. The set screw 42 is then assembled to opening 80A of the main body 40 with the tip 48 towards the slot 46. The assembled beam clamp 30 can then be used to support an object relative to a flanged support structure, as illustrated in FIG. 1. The flange 16, 18 is inserted into the slot 46 of the beam clamp 30. The beam clamp 30 can be positioned with the set screw 42 on either side of the flange 16, 18. That is, the beam clamp 30 can be oriented with the set screw 42 up or down. Once the flange 16, 18 is present within the slot 46, the set screw 42 can be tightened to secure the beam clamp 30 to the flange 16, 18. So installed, the beam clamp 30 advantageously provides a three point engagement with the flange 16, 18 (set screw tip 48, surface 66 of side wall 52 and surface 66 of side wall 54). With the clamp 30 installed, a support rod 32 can be assembled to threaded opening 80B of the beam clamp 30 and used to support an object, such as a pipe 12, directly or through one or more intermediate devices, such as a pipe hanger 34. Of course, the support rod 32 can be coupled to the beam clamp 30 before the beam clamp 30 is coupled to a flanged support structure; however, it is preferable to install the support rod 32 later because its presence can interfere with a tool used to tighten the set screw 42.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present beam clamp has been described in the context of particularly preferred embodiments, the skilled artisan will appreciate, in view of the present disclosure, that certain advantages, features and aspects of the system may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A beam clamp for mounting to a flange of a beam or other support, comprising:
a main body having an end wall, a first side wall and a second side wall, the first side wall defines a first slot having an open end and a closed end, the second side wall has a second slot having an open end and a closed end, wherein the first slot and the second slot open in the same direction and are configured to receive the flange, wherein the end wall, the first side wall and the second side wall of the main body are formed by a unitary piece of material having a wall thickness, the main body further comprising a first protrusion and a second protrusion that extend unitarily from the end wall, a first threaded opening and a second threaded opening pass through the end wall and a respective one of the first and second protrusions such that each of the first threaded opening and the second threaded opening define a thread length that is greater than the wall thickness;
a set screw engaged with the first threaded opening.

2. The beam clamp of claim 1, wherein the first and second protrusions extend in the same direction from the end wall as the first and second side walls.

3. The beam clamp of claim 2, wherein an end of each of the first and second protrusions is substantially aligned with an edge of each of the first and second slots closest to the end wall.

4. The beam clamp of claim 1, wherein the thread length of each of the first and second threaded openings is approximately equal to or greater than a diameter of the respective one of the first and second threaded openings.

5. The beam clamp of claim 4, wherein the thread length of the first threaded opening is equal to the thread length of the second threaded opening.

6. The beam clamp of claim 4, wherein the diameter of the first threaded opening is equal to the diameter of the second threaded opening.

7. The beam clamp of claim 1, wherein the first threaded opening and the second threaded opening are spaced from one another in a longitudinal direction of the main body.

8. The beam clamp of claim 7, wherein the first threaded opening is aligned with the first and second slots such that the set screw can engage the flange.

9. The beam clamp of claim 8, wherein the second threaded opening is between the closed ends of the first and second slots and an edge of the main body opposite the open ends of the first and second slots such that a threaded rod received by the second threaded opening and extending from the end wall to an edge of the first and second side walls opposite the end wall will not interfere with the flange received within the first and second slots.

10. A method of manufacturing a beam clamp configured to be clamped to a flange of a beam or other support, comprising:
stamping a flat work piece having an end wall portion, a first side wall portion extending from one edge of the end wall portion and a second side wall portion extending from an opposite edge of the end wall portion, the stamping comprising creating a first slot in the first side wall portion, the first slot having an open end and a closed end, and creating a second slot in the second side wall portion, the second slot having an open end and a closed end, wherein the first and second slots open in the same direction, the stamping further comprising creating a first opening having a first initial diameter and creating a second opening having a second initial diameter;
bending the first side wall portion approximately ninety degrees relative to the end wall portion;
bending the second side wall portion approximately ninety degrees relative to the end wall portion in the same direction as the first side wall portion;
deforming a portion of the work piece surrounding the first opening to create a first protrusion surrounding the first opening and thereby enlarging the first opening such that the first opening defines a first enlarged diameter that is greater than the first initial diameter;
deforming a portion of the work piece surrounding the second opening to create a second protrusion surrounding the second opening and thereby enlarging the second opening such that the second opening defines a second enlarged diameter that is greater than the second initial diameter;
creating threads in the first opening and creating threads in the second opening.

11. The method of claim 10, wherein the bending and deforming comprises bending the first and second side wall portions and creating the first and second protrusions all extending in the same direction from the end wall portion.

12. The method of claim 10, further comprising spacing the first opening and the second opening in a longitudinal direction along the end wall portion, aligning the first opening with the first and second slots and aligning the second opening with a portion of the first and second side walls behind a closed end of the first and second slots.

13. The method of claim 10, further comprising threading a set screw into the first opening.

14. The method of claim 13, further comprising threading a nut onto the set screw prior to the threading of the set screw into the first opening.

15. The method of claim 10, wherein the bending of the first side wall and second side wall portions is done prior to the deforming that creates the first and second protrusions.

16. An assembly, comprising:
a beam having a flange;
a beam clamp comprising a main body and a set screw, the main body having an end wall and first and second side walls created by a unitary piece of material having a wall thickness, the first and second side walls extending in the same direction from the end wall, each of the first and second side walls defining a slot that open in the same direction relative to the main body, the end wall comprising a first protrusion and a second protrusion, a first threaded opening passes through the end wall at the first protrusion and a second threaded opening passes through the end wall at the second protrusion such that the first threaded opening defines a first thread length and the second threaded opening defines a second thread length, and both the first and second thread lengths are greater than the wall thickness, wherein the main body is placed onto the beam with the flange positioned within the slots of the first and second side walls, the set screw is threaded into the first threaded opening and engaged with the flange to secure the beam clamp to the beam;
a threaded rod having a first end portion and a second end portion, the first end portion is threaded into the second threaded opening;
a pipe hanger coupled to the second end portion of the threaded rod; and
a pipe supported by the pipe hanger.

17. The assembly of claim 16, wherein the beam clamp is oriented such that the set screw engages a bottom surface of the beam flange.

18. The assembly of claim 16, wherein the beam clamp is oriented such that the set screw engages a top surface of the beam flange.

19. The assembly of claim 16, wherein the first protrusion and the second protrusion extend in the same direction as the first and second side walls.

20. The assembly of claim 16, wherein the first protrusion and the second protrusion extend in only one direction from the end wall.
